(19) United States
(12) Patent Application Publication
(10) Pub. No.: US 2023/0351989 A1
(43) Pub. Date: Nov. 2, 2023

(54) INFORMATION PROCESSING SYSTEM, ELECTRONIC MUSICAL INSTRUMENT, AND INFORMATION PROCESSING METHOD

(71) Applicant: YAMAHA CORPORATION, Hamamatsu-shi (JP)

(72) Inventors: Masafumi SOBAJIMA, Hamamatsu-shi (JP); Dan SASAI, Hamamatsu-shi (JP)

(21) Appl. No.: 18/349,417

(22) Filed: Jul. 10, 2023

Related U.S. Application Data
(63) Continuation of application No. PCT/JP2021/048897, filed on Dec. 28, 2021.

(30) Foreign Application Priority Data
Jan. 13, 2021 (JP) 2021-003525

(51) Int. Cl. G10H 1/00; G10H 1/36

(52) U.S. Cl. CPC G10H 1/0008; G10H 1/36; G10H 2250/005

(57) ABSTRACT

An information processing system includes at least one memory configured to store instructions and at least one processor configured to implement the instructions to acquire first audio data indicative of audio of a target piece of music, and cause a trained model to output first timbre data indicative of a timbre appropriate for the target piece of music by inputting input data into the trained model, the input data including the first audio data, in which the trained model is trained to learn a relationship between second audio data indicative of audio and second timbre data indicative of a timbre for each reference piece of a plurality of reference pieces of music.

### CROSS REFERENCE TO RELATED APPLICATIONS

This application is a Continuation Application of PCT Application No. PCT/JP2021/048897, filed on Dec. 28, 2021, and is based on, and claims priority from, Japanese Patent Application No. 2021-003525, filed on Jan. 13, 2021, the entire contents of which are incorporated herein by reference.

### BACKGROUND

### Technical Field

This disclosure relates to a technique for processing information for a piece of music.

### Background Information

There have been proposed electronic musical instruments that are capable of reproducing a piece of music played by a user with one timbre among multiple timbres. For example, Japanese Patent Application Laid-Open Publication No. 2007-140308 discloses a technique for setting an appropriate timbre for a piece of music played by a user. In the technique described in Japanese Patent Application Laid-Open Publication No. 2007-140308, it is necessary to register in advance a timbre for a piece of music. As a result, it is not possible to set an appropriate timbre for a new piece of music that has not been registered in advance, such as a piece of music that is created by a user.

### SUMMARY

An object of one aspect of this disclosure is to identify a timbre for a new piece of music.

In one aspect, an information processing system includes at least one memory configured to store instructions and at least one processor configured to implement the instructions to: acquire first audio data indicative of audio of a target piece of music; and cause a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality of reference pieces of music.

In another aspect, an electronic musical instrument includes at least one memory configured to store instructions and at least one processor configured to implement the instructions to: acquire first audio data indicative of audio of a target piece of music; cause a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality of reference pieces of music; and cause a sound emitting device to emit sound with a timbre that corresponds to the first timbre data in accordance with playing of a piece of music.

In yet another aspect, a computer-implemented information processing method includes acquiring first audio data indicative of audio of a target piece of music; and causing a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality pf reference pieces of music.

In yet another aspect, a recording medium is a non-transitory computer-readable recording medium configured to store a program executable by at least one processor to perform an information processing method, the method including: acquiring first audio data indicative of audio of a target piece of music; and causing a trained model to output first timbre data indicative of a timbre appropriate for the target piece of music by inputting input data into the trained model, the input data including the first audio data, and the trained model in trained to learn a relationship between second audio data indicative of audio and second timbre data indicative of a timbre for each reference piece of a plurality of reference pieces of music.

### BRIEF DESCRIPTION OF THE DRAWINGS

FIG. 1 is a block diagram showing a configuration of a playing system according to a first embodiment.

FIG. 2 is a block diagram showing a configuration of an electronic musical instrument.

FIG. 3 is a block diagram showing a configuration of an information processing system.

FIG. 4 is a block diagram showing a functional configuration of the information processing system.

FIG. 5 is a block diagram showing a configuration of a trained model.

FIG. 6 is a flowchart showing an analysis processing procedure.

FIG. 7 is a flowchart showing a playing processing procedure.

FIG. 8 is a block diagram showing a configuration of a machine learning system.

FIG. 9 is a block diagram showing a functional configuration of the machine learning system.

FIG. 10 is a flowchart showing a learning processing procedure.

FIG. 11 is a block diagram showing a functional configuration of the information processing system according to a second embodiment.

FIG. 12 is a schematic diagram of reference data.

FIG. 13 is a flowchart showing an estimation processing procedure.

FIG. 14 is a schematic diagram of a selection screen.

FIG. 15 is a flowchart showing a control processing procedure.

FIG. 16 is a block diagram showing a functional configuration of the electronic musical instrument according to a third embodiment.

FIG. 17 is a block diagram showing a configuration of the playing system according to a fourth embodiment.

FIG. 18 is a block diagram showing a configuration of the playing system according to a fifth embodiment.

### DETAILED DESCRIPTION

### A: First Embodiment

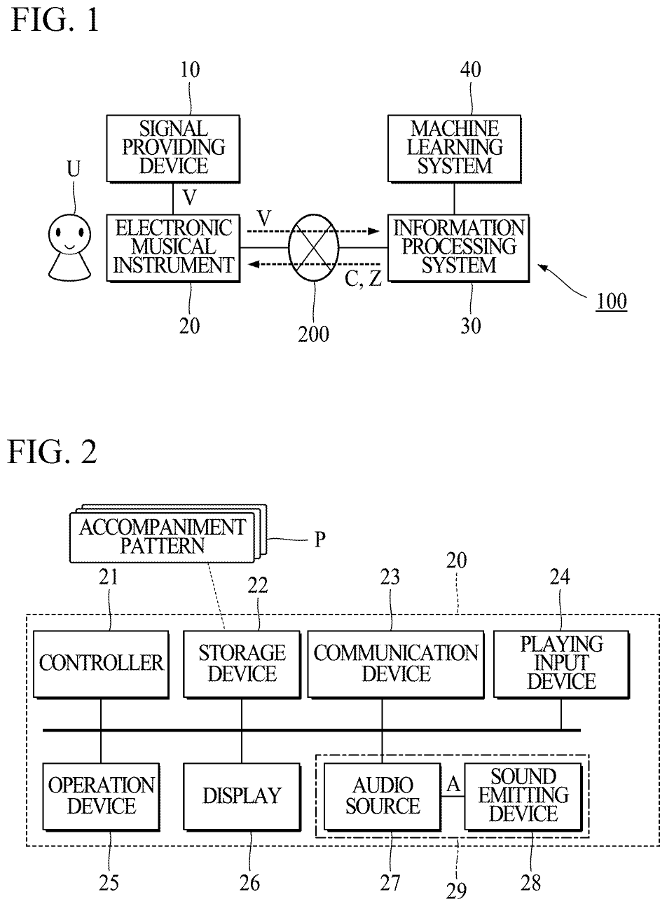

FIG. 1 is a block diagram showing a configuration of a playing system 100 according to a first embodiment. The playing system 100 is a computer system that is used by a user U to play a desired piece of music (hereinafter referred to as “a target piece of music”). The playing system 100 includes a signal providing device 10, an electronic musical instrument 20, an information processing system 30, and a machine learning system 40. The signal providing device 10 is connected to the electronic musical instrument 20 either by wire or wirelessly. The electronic musical instrument 20 and the information processing system 30 communicate with each other via a communication network 200 such as the Internet.

The signal providing device 10 provides the electronic musical instrument 20 with an audio signal V. The audio signal V is a time series of samples representative of a waveform of audio of the target piece of music. The audio of the target piece of music may be referred to as “instrumental audio.” The signal providing device 10 may be a reproduction device configured to provide the electronic musical instrument 20 with the audio signal V prerecorded in a recording medium such as a compact disc (CD). Alternatively, the signal providing device 10 may be a communication device configured to provide the electronic musical instrument 20 with the audio signal V received from a distribution device (not shown) via the communication network 200. The signal providing device 10 may be an information terminal device such as a smartphone or a tablet terminal. The signal providing device may be a sound receiving device configured to receive sound in its vicinity to generate the audio signal V. The sound receiving device may receive sound emitted from a musical instrument played by the user U. The sound receiving device may receive sound emitted from the user U singing a song. The signal providing device 10 may be included in the electronic musical instrument 20.

The electronic musical instrument 20 is used by the user U to play the target piece of music. The audio signal V is provided from the signal providing device 10, and is transmitted from the electronic musical instrument to the information processing system 30. The information processing system 30 analyzes the audio signal V to generate accompaniment data C and timbre data Z. The accompaniment data C is data indicative of an accompaniment pattern P appropriate for the target piece of music. The accompaniment data C may be generated as identification information for identifying an accompaniment pattern from among different accompaniment patterns P. Each of the accompaniment patterns P is a signal representative of accompaniment audio. An example of an accompaniment pattern P is a rhythm pattern constituted of audio of a percussion instrument such as drums.

The timbre data Z is data indicative of a timbre appropriate for the target piece of music. The timbre data Z may be generated as identification information for identifying one timbre from among different timbres that correspond to different musical instruments (for example, piano, violin, guitar, etc.). The timbre data Z may indicate one timbre from among different timbres that can be produced by a musical instrument. For example, a bowed stringed instrument can produce different timbres depending on a playing technique, bowing, plucking, etc. Thus, the timbre data Z may indicate a timbre corresponding to a timbre produced by a musical instrument depending on a playing technique.

The accompaniment data C and the timbre data Z generated by the information processing system 30 are transmitted to the electronic musical instrument 20 from which the audio signal V is transmitted. The electronic musical instrument 20 executes in parallel first processing and second processing. The first processing reproduces the accompaniment audio in accordance with the accompaniment pattern P indicated by the accompaniment data C, and the second processing reproduces the audio (instrumental audio) with the timbre indicated by the timbre data Z, in accordance with playing of a piece of music by the user U. As will be understood from the above description, by use of the electronic instrument 20, the user U can play the target piece of music with a timbre appropriate for the target piece of music concomitantly with reproduction of accompaniment audio with the accompaniment pattern P appropriate for the target piece of music.

FIG. 2 is a block diagram showing a configuration of the electronic musical instrument 20. The electronic musical instrument 20 includes a computer system that includes a controller 21, a storage device 22, a communication device 23, a playing input device 24, an operation device 25, a display 26, an audio source 27, and a sound emitting device 28. The electronic musical instrument 20 may be constituted of a single integrated device, or may be constituted of a plurality of separate devices.

The controller 21 is constituted of one or more processors configured to control components of the electronic musical instrument 20. The controller 21 may be constituted of one or more types of processors such as a central processing unit (CPU), a sound processing unit (SPU), a digital signal processor (DSP), a field programmable gate array (FPGA), or an application specific integrated circuit (ASIC).

The storage device 22 includes one or more memories configured to store a program executed by the controller 21 and a variety of types of data used by the controller 21. The storage device 22 may be constituted of a known recording medium such as a magnetic recording medium or a semiconductor recording medium, or alternatively the storage device 22 may be constituted of a combination of different types of recording media. The storage device 22 may be a portable recording medium that is detachable from the electronic musical instrument 20. The storage device 22 may be a recording medium (for example, a cloud storage server) that is accessible by the controller 21 via the communication network 200. The audio signal V may be stored in the storage device 22.

The storage device 22 according to the first embodiment stores different accompaniment patterns P. Musical elements, such as a beat (for example, in four-four time signature, or in three-four time signature), a type of musical instrument, a rhythm, etc., differ between different accompaniment patterns P. Among the accompaniment patterns P stored in the storage device 22, the accompaniment pattern P indicated by the accompaniment data C from the information processing system 30 is selectively processed. Thus, the accompaniment audio that corresponds to the accompaniment pattern P appropriate for the target piece of music is reproduced.

The communication device 23 communicates with the information processing system 30 via the communication network 200. The communication device 23 transmits the audio signal V of the target piece of music to the information processing system 30. The communication device 23 receives the accompaniment data C and the timbre data Z transmitted from the information processing system 30. A communication link between the electronic musical instrument 20 and the information processing system 30 may or may not include a wireless section. The communication device 23 may be provided separate from the electronic musical instrument 20 and connected to the electronic musical instrument 20 either by wire or wirelessly. The communication device 23 provided separate from the electronic musical instrument 20 may be an information terminal device such as a smartphone or a tablet terminal.

The playing input device 24 is a device configured to receive input from the user U for playing a piece of music. The playing input device 24 includes a keyboard that has a plurality of keys corresponding to different pitches, for example. The user U plays the target piece of music by operating in a sequence keys of the playing input device 24. The playing input device 24 is not limited to a keyboard. The playing input device 24 is an example of a “receiver configured to receive input for playing a piece of music.”

The operation device 25 is an input device configured to receive instructions from the user U. The operation device 25 may be constituted of a plurality of elements operable by the user U, or may be constituted of a touch panel that detects contact made by the user U. The display 26 displays images under control of the controller 21. The display 26 may include a display panel such as a liquid crystal display panel or an organic electroluminescence (EL) panel.

The audio source 27 generates a playing signal A that corresponds to playing of the playing input device 24. The playing signal A is an audio signal representative of a waveform of audio that corresponds to the playing of the playing input device 24. An example of the playing signal A generated by the audio source 27 is a signal representative of audio with a pitch that corresponds to a key operated by the user U among the plurality of keys of the playing input device 24. The timbre of the audio represented by the playing signal A is dynamically set to one timbre among a plurality of different timbres. The audio source 27 may generate, as an example of the playing signal A, a signal representative of audio with a timbre indicated by the timbre data Z from the information processing system 30.

The audio source 27 is capable of generating, as an example of the playing signal A, an audio signal generated by mixing audio corresponding to the playing of the playing input device 24 by the user U together with accompaniment audio represented by the accompaniment pattern P. The controller 21 may execute the program stored in the storage device 22 to implement the functions of the audio source 27. In this case, (when the audio source 27 is dedicated to generating the playing signal A,) the audio source 27 may be omitted. The playing signal A generated by the audio source 27 may be transmitted as the audio signal V to the information processing system 30.

The sound emitting device 28 emits the sound (instrumental audio) represented by the playing signal A. The sound emitting device 28 may be a loudspeaker or headphones. In a state in which the electronic musical instrument 20 receives the accompaniment data C and the timbre data Z from the information processing system 30, the user U can play the target piece of music with the timbre indicated by the timbre data Z concomitantly with the reproduction of the accompaniment audio, which corresponds to the accompaniment pattern P indicated by the accompaniment data C. As will be understood from the above description, the audio source 27 and the sound emitting device 28 in the first embodiment function as a reproduction device 29 configured to reproduce the audio with the timbre indicated by the timbre data Z, in accordance with the playing of a piece of music by the user U. Playing of a piece of music by the user U may be referred to as “playing by the user U.”

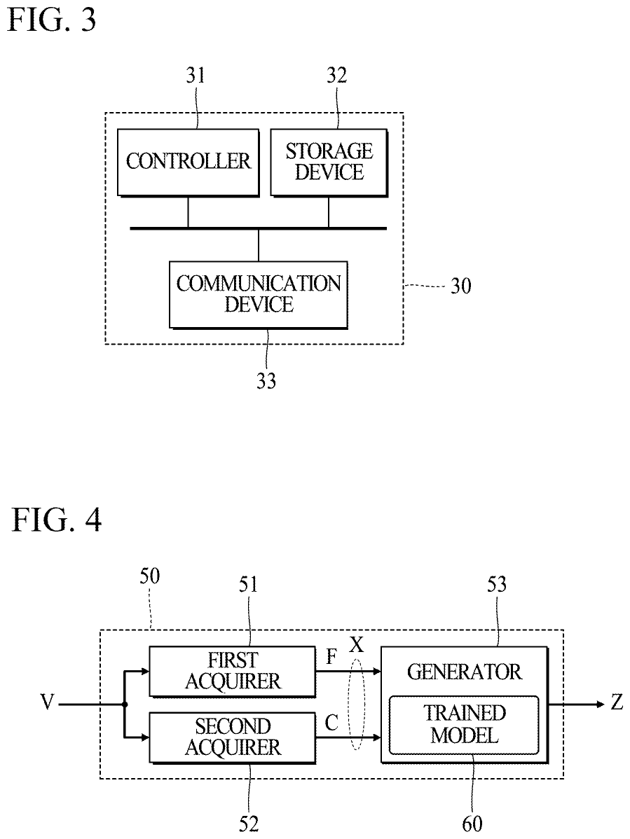

FIG. 3 is a block diagram showing a configuration of the information processing system 30. The information processing system 30 is implemented in a computer system that includes a controller 31, a storage device 32, and a communication device 33. The information processing system 30 may be a constituted of a single integrated device, or may be constituted of a plurality of separate devices.

The controller 31 is constituted of one or more processors configured to control components of the information processing system 30. The controller 31 may be constituted of one or more types of processors such as a CPU, an SPU, a DSP, an FPGA, or an ASIC.

The storage device 32 includes one or more memories configured to store a program executed by the controller 31 and a variety of types of data used by the controller 31. The storage device 32 may be constituted of a known recording medium, such as a magnetic recording medium or a semiconductor recording medium. Alternatively, the storage device 32 may be constituted of a combination of different types of recording media. The storage device 32 may be a portable recording medium that is detachable from the information processing system 30. The storage device 32 may be a recording medium (for example, a cloud storage server) that is accessible to the controller 31 via the communication network 200.

The communication device 33 communicates with the electronic musical instrument 20 via the communication network 200. The communication device 33 receives the audio signal V transmitted from the electronic musical instrument 20. The communication device 33 transmits the accompaniment data C and the timbre data Z to the electronic musical instrument 20.

FIG. 4 is a block diagram showing a functional configuration of the information processing system 30. The controller 31 of the information processing system 30 executes the program stored in the storage device 32 to function as an analysis processor 50. The analysis processor 50 analyzes the audio signal V to generate the accompaniment data C and the timbre data Z. The analysis processor 50 includes a first acquirer 51 and a second acquirer 52, and a generator 53.

The first acquirer 51 acquires audio data F indicative of the audio (instrumental audio) of the target piece of music. The audio data F is an example of first audio data. The first acquirer 51 analyzes the audio signal V to generate the audio data F. The audio data F may be generated from a part of the audio signal V or from the entire audio signal V. The audio data F is data indicative of a temporal change in the audio of the target piece of music. For example, the audio data F is data indicative of a time series of frequency characteristics related to the audio of the target piece of music. The audio data F may be data indicative of a time series of frequency characteristics such as Mel-frequency cepstrum coefficient (MFCC), Mel-scale log spectrum (MSLS), or Constant-Q transform (CQT). The audio data F may be referred to as data indicative of a feature (timbre feature) related to the timbre of the audio represented by the audio signal V. To generate the audio data F, a known frequency analysis technique such as a short-time Fourier transform may be used, for example. The time series of samples of the audio signal V may be used as audio data F.

The second acquirer 52 acquires the accompaniment data C indicative of the accompaniment pattern P appropriate for the target piece of music. The accompaniment data C is an example of first accompaniment data. The second acquirer 52 analyzes the audio signal V to generate the accompaniment data C. The accompaniment data C may be generated from a part of the audio signal V or from the entire audio signal V. For example, a part of the audio signal V may be used to generate the audio data F by the first acquirer 51, and a part of the audio signal V may be used to generate the accompaniment data C by the second acquirer 52. The second acquirer 52 first analyzes the audio signal V to estimate a musical genre of the target piece of music, for example. To estimate the musical genre, a known technique as described in Japanese Patent Application Laid-Open Publication No. 2015-79110 may be used, for example. The second acquirer 52 identifies a piece of accompaniment data C, which corresponds to the musical genre estimated for the target piece of music, from among different pieces of accompaniment data C that correspond to different musical genres. The second acquirer 52 may analyze the audio data F to identify the accompaniment data C. The different pieces of accompaniment data C, each of which is candidate for acquisition by the second acquirer 52, are stored in the storage device 32, for example.

The generator 53 generates the timbre data Z based on input data X that includes the audio data F acquired by the first acquirer 51 and the accompaniment data C acquired by the second acquirer 52. The timbre data Z is an example of first timbre data. For example, the generator 53 generates the timbre data Z indicative of a timbre appropriate for a combination of the audio represented by the audio signal V and the accompaniment pattern P indicated by the accompaniment data C. To generate the timbre data Z, the generator 53 uses a trained model 60. The timbre of the audio represented by the audio signal V may be the same as or different from the timbre indicated by the timbre data Z.

A correlation is made between a temporal change (audio data F) in audio (instrumental audio) of a piece of music and a timbre frequently used in playing the piece of music. In addition, a correlation is made between an accompaniment pattern P appropriate for a piece of music and the timbre frequently used in playing the piece of music. The trained model 60 is a statistical estimation model that is trained to learn the correlations described above. In other words, the trained model 60 is a statistical estimation model that is trained, by machine learning, to learn, for each reference piece of a plurality of reference pieces of music, a relationship between (i) a combination of audio and an accompaniment pattern P, and (ii) a timbre. The reference pieces of music are known pieces of music. Specifically, the trained model 60 is a statistical estimation model that is trained to learn, for each reference piece of the plurality of reference pieces of music, a relationship between input data (a combination of second audio data indicative of audio and second accompaniment data indicative of an accompaniment pattern), and second timbre data indicative of a timbre. The generator 53 causes the trained model 60 to output the timbre data Z by inputting into the trained model 60 the input data X that includes the audio data F and the accompaniment data C. A timbre frequently used for a reference piece of music may be referred to as a timbre appropriate for the reference piece of music (a timbre appropriate for playing the reference piece of music).

The trained model 60 is constituted of a deep neural network (DNN), for example. The trained model 60 may be a freely selected neural network, such as a recurrent neural network (RNN) or a convolutional neural network (CNN). The trained model 60 may be constituted of a combination of different deep neural networks. The trained model 60 may include additional elements, such as long short-term memory (LSTM).

The trained model 60 is implemented by a combination of a program, which causes the controller 31 to execute an operation to generate the timbre data Z from the input data X, and multiple variables for the operation. The multiple variables for the trained model 60 include weights and biases, for example. The program and the multiple variables for implementing the trained model 60 are stored in the storage device 32. Numerical values of the multiple variables for implementing the trained model 60 are set in advance by machine learning.

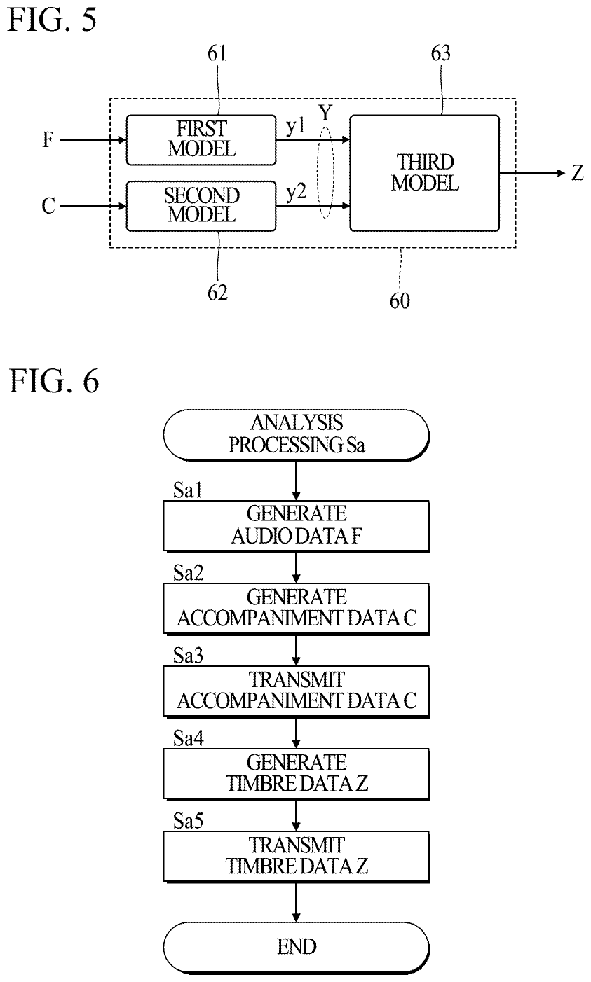

FIG. 5 is a block diagram showing a configuration of the trained model 60. The trained model 60 includes a first model 61, a second model 62, and a third model 63. The audio data F of the input data X is input into the first model 61, whereas the accompaniment data C of the input data X is input into the second model 62.

The first model 61 generates first data y1 indicative of a feature of the audio (instrumental audio) of the target piece of music from the audio data F. The first model 61 is a trained model that is trained to learn a relationship between the audio data F and the first data y1. In other words, the first model 61 is a model configured to extract a feature of the audio data F. The first data y1 is data indicative of the feature of the audio data F. The feature of the audio data F is used to generate the timbre data Z appropriate for the target piece of music from the input data X of the trained model 60.

For example, in a configuration in which the first model 61 is constituted of a convolution neural network, the time series of frequency characteristics indicated by the audio data F (i.e., a group of numerical values distributed in a time-frequency domain) is input into the first model 61 as a two-dimensional image. In a configuration in which the first model 61 is constituted of a recurrent neural network, numerical values of the audio data F corresponding to points on a time axis are input into the first model 61 in order of time. In a configuration in which the first model 61 is constituted of a combination of a convolution neural network and a recurrent neural network, numerical values of the audio data F corresponding to points on a time axis are input into the convolution neural network in order of time. Output data output from the convolution neural network for each point in time is input into the recurrent neural network in order of time.

The second model 62 generates second data y2 indicative of a feature of the accompaniment pattern P from the accompaniment data C. The second model 62 is a trained model that is trained to learn a relationship between the accompaniment data C and the second data y2. The second model 62 is a model configured to convert the identification information of the accompaniment pattern P indicated by the accompaniment data C into the second data y2. The second model 62 may be constituted of a convolution neural network.

The second data y2 is an embedding vector that is set in a multi-dimensional virtual space, for example. The virtual space includes consecutive spaces. The position of the accompaniment pattern P (i.e., coordinate designated by the second data y2) in the virtual space is determined based on an audio feature of the accompaniment pattern P. The greater a similarity of audio features of accompaniment patterns P to each other, the smaller a distance between coordinates specified by pieces of second data y2 of the accompaniment patterns P in the virtual space. The virtual space may be referred to as a space representative of a relationship between the accompaniment patterns P.

The first data y1 and the second data y2 are included in intermediate data Y. The intermediate data Y is input into the third model 63. The third model 63 is a trained model that is trained to learn a relationship between the intermediate data Y and the timbre data Z. The third model 63 generates the timbre data Z from the intermediate data Y. The third model 63 may be constituted of a recurrent neural network or of a convolutional neural network.

FIG. 6 is a flowchart showing a processing procedure (hereinafter referred to as “analysis processing”) Sa in which the controller 31 generates the timbre data Z. For example, the analysis processing Sa starts in response to receipt of the audio signal V of the target piece of music transmitted from the electronic musical instrument 20.

When the analysis processing Sa starts, the first acquirer 51 analyzes the audio signal V to generate the audio data F (Sa1), and the second acquirer 52 analyzes the audio signal V to generate the accompaniment data C (Sa2). The second acquirer 52 transmits the accompaniment data C from the communication device 33 to the electronic musical instrument 20 (Sa3). The order of the generation (Sa1) of the audio data F by the first acquirer 51 and the generation (Sa2) and the transmission (Sa3) of the accompaniment data C by the second acquirer 52 may be reversed.

The generator 53 causes the trained model 60 to output the timbre data Z by inputting the input data X, which includes the audio data F and the accompaniment data C, into the trained model 60 (Sa4). The generator 53 transmits the timbre data Z from the communication device 33 to the electronic musical instrument 20 (Sa5). The accompaniment data C, together with the timbre data Z, may be transmitted to the electronic musical instrument 20.

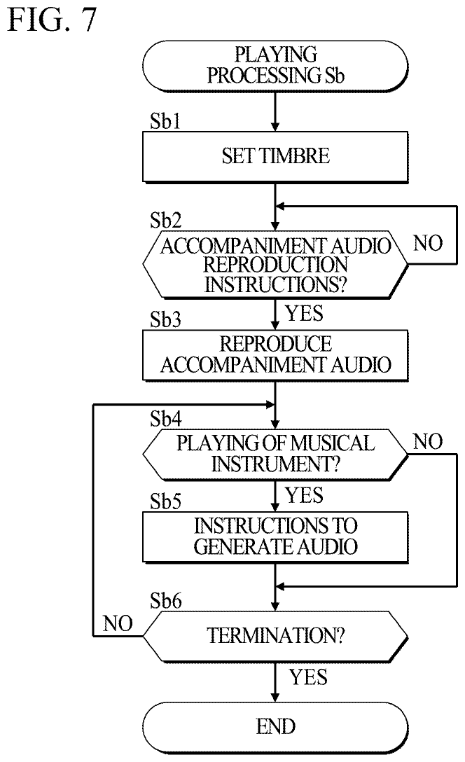

FIG. 7 is a flowchart showing a processing procedure (hereinafter referred to as “playing processing”) Sb executed by the controller 21 of the electronic musical instrument 20 that receives the accompaniment data C and the timbre data Z. The playing processing Sb starts in response to receipt of the accompaniment data C and the timbre data Z.

When the playing processing Sb starts, the controller 21 instructs the audio source 27 of the timbre indicated by the timbre data Z (Sb1). Thus, the audio source 27 is able to generate the playing signal A, which is representative of the audio with the timbre indicated by the timbre data Z, in accordance with an operation of the playing input device 24 by the user U.

By operating the operation device 25, the user U can provide an instruction to reproduce the accompaniment audio that corresponds to the accompaniment pattern P. The controller 21 waits for the user U to provide the instruction to reproduce the accompaniment audio that corresponds to the accompaniment pattern P (Sb2: NO). In response to the user U providing the instruction to reproduce the accompaniment audio that corresponds to the accompaniment pattern P (Sb2: YES), the controller 21 instructs the audio source 27 to reproduce the accompaniment audio that corresponds to the accompaniment pattern P indicated by the accompaniment data C from the information processing system 30 (Sb3).

The controller 21 determines whether the playing input device 24 is played by the user U (Sb4). In response to a determination that the playing input device 24 is played by the user U (Sb4: YES), the controller 21 instructs the audio source 27 to generate audio with a pitch that corresponds to a key operated by the user U (Sb5). The audio source 27 generates the playing signal A representative of the audio with the timbre indicated by the timbre data Z. Consequently, the audio generated in accordance with the playing of the playing input device 24 by the user U, together with the accompaniment audio that corresponds to the accompaniment pattern P, is output as sound from the sound emitting device 28. In response to a determination that the playing input device 24 is not played by the user U (Sb4: NO), the reproduction of the audio (Sb5) is not executed.

The controller 21 repeats the processing (Sb4, Sb5) to instruct the audio source 27 to reproduce the audio until the user U provides an instruction to terminate the playing (Sb6: NO). In response to the user U providing the instruction to terminate the playing (Sb6: YES), the controller 21 terminates the playing processing Sb.

According to the first embodiment, the timbre data Z indicative of a timbre appropriate for the target piece of music is generated based on input of the input data X, which includes the audio data F indicative of the audio of the target piece of music, into the trained model 60. Thus, it is possible to identify an appropriate timbre for a new piece of music, for example. In the first embodiment, the input data X is input into the trained model 60. The input data X includes not only the audio data F indicative of the audio of the target piece of music, but also the accompaniment data C indicative of the accompaniment pattern P that corresponds to the target piece of music. Accordingly, it is possible to identify a timbre appropriate for a combination of the audio of the target piece of music and also the accompaniment pattern P that corresponds to the target piece of music.

In addition, the first embodiment has an advantage in that an appropriate accompaniment pattern P and an appropriate timbre can be selected even if the user U does not have requisite musical knowledge to select a timbre appropriate for the target piece of music or to select an accompaniment pattern P appropriate for the target piece of music. In addition, an advantage is obtained in that an effort required by the user U to select an appropriate timbre and an appropriate accompaniment pattern P can be reduced.

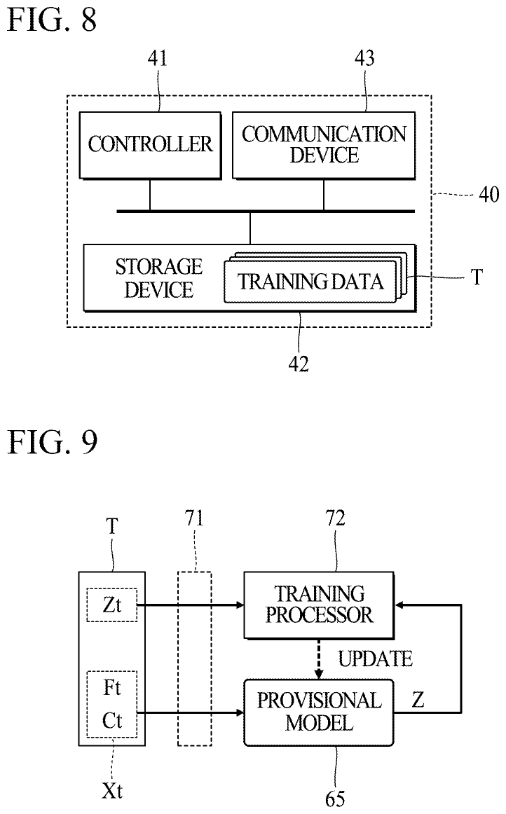

The machine learning system 40 in FIG. 1 generates the trained model 60. FIG. 8 is a block diagram showing a configuration of the machine learning system 40. The machine learning system 40 includes a controller 41, a storage device 42, and a communication device 43. The machine learning system 40 may be constituted of a single integrated device, or may be constituted of a plurality of separate devices.

The controller 41 is constituted of one or more processors configured to control components of the machine learning system 40. The controller 41 may be constituted of one or more types of processors such as a CPU, an SPU, a DSP, an FPGA, or an ASIC. The communication device 43 communicates with the information processing system 30.

The storage device 42 includes one or more memories configured to store a program executed by the controller 41 and a variety of types of data used by the controller 41. The storage device 42 may be constituted of a known recording medium such as a magnetic recording medium or a semiconductor recording medium. Alternatively, the storage device 42 may be constituted of a combination of different types of recording media. The storage device 42 may be a portable recording medium that is detachable from the machine learning system 40. The storage device 42 may be a recording medium (for example, a cloud storage server) that is accessible to the controller 41 via the communication network 200.

FIG. 9 is a block diagram showing a functional configuration of the machine learning system 40. The controller 41 executes the program stored in the storage device 42 to function as a plurality of elements (a training data acquirer 71 and a training processor 72) configured to establish the trained model 60 by machine learning.

The training processor 72 establishes the trained model 60 by supervised machine learning (learning processing Sc described below) using multiple pieces of training data T. The training data acquirer 71 acquires the multiple pieces of training data T. For example, the training data acquirer 71 acquires the multiple pieces of training data T from the storage device 42 that stores the multiple pieces of training data T.

Each of the multiple pieces of training data T is constituted of a combination of training input data Xt and training timbre data Zt. The training input data Xt includes both audio data Ft of a known reference piece of music and accompaniment data Ct of an accompaniment pattern P appropriate for the reference piece of music. The audio data Ft is generated from recorded playing of the reference piece of music. The audio data Ft is another example of second audio data. The accompaniment pattern P indicated by the accompaniment data Ct is selected based on a musical feature (for example, a melody or a beat, etc.) of the reference piece of music by a creator of the training data T, for example. The accompaniment data Ct is another example of second accompaniment data.

The timbre data Zt of a piece of training data T among the multiple pieces of training data T is data indicative of a timbre appropriate for a reference piece of music that corresponds to the piece of training data T. In other words, the timbre data Zt of a piece of training data T among the multiple pieces of training data T corresponds to a ground truth (label) for the input data Xt of the piece of training data T. The timbre data Zt is another example of second timbre data. The timbre data Zt is selected based on a musical feature of a combination of the reference piece of music and the accompaniment pattern P indicated by the accompaniment data Ct by the creator of the training data T, for example.

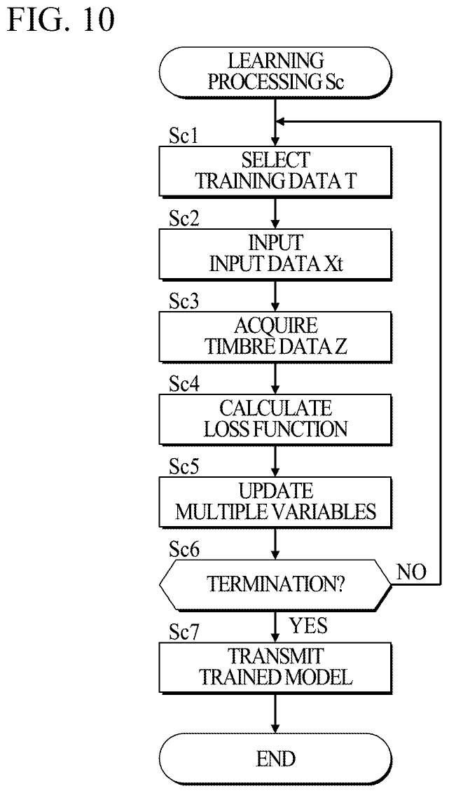

FIG. 10 is a flowchart showing a procedure of the learning processing Sc in which the controller 41 establishes the trained model 60. The learning processing Sc may be referred to as a method (trained model generation method) of generating the trained model 60 by machine learning.

When the learning processing Sc starts, the training data acquirer 71 acquires one (hereinafter referred to as selected training data T) of the multiple pieces of training data T stored in the storage device 42 (Sc1). As shown in FIG. 9, the training processor 72 inputs the input data Xt, which is the selected training data T, into an initial or provisional model (hereinafter referred to as a “provisional model 65”) (Sc2) to acquire timbre data Z output from the provisional model 65 in response to input of the input data Xt (Sc3).

The training processor 72 calculates a loss function indicative of a difference between the timbre data Z generated by the provisional model 65 and the timbre data Zt of the selected training data T (Sc4). The training processor 72 updates multiple variables for the provisional model 65 such that the loss function is reduced (ideally, minimized) (Sc5). To update the multiple variables in accordance with the loss function, a backpropagation method is used, for example.

The training processor 72 determines whether a termination condition is satisfied (Sc6). The termination condition may be a condition in which the loss function is less than a predetermined threshold. Alternatively, the termination condition may be a condition in which the amount of a change in the loss function is less than a predetermined threshold. When the termination condition is not satisfied (Sc6: NO), the training data acquirer 71 reads out new selected training data T that has not yet been selected (Sc1). Thus, until the termination condition is satisfied (Sc6: YES), processing to update the multiple variables for the provisional model 65 (Sc2 to Sc5) is repeated. When the termination condition is satisfied (Sc6: YES), the training processor 72 terminates the updating (Sc2 to Sc5) of the multiple variables that define the provisional model 65. The provisional model 65, which is at a point in time at which the termination condition is satisfied, is defined as trained model 60. In other words, the multiple variables of the trained model 60 are defined as values that are at a point in time at which the learning processing Sc is terminated.

As will be understood from the above description, the trained model 60 outputs statistically reasonable timbre data Z for unknown input data X based on a potential relationship between the input data Xt of the multiple pieces of training data T and the timbre data Zt of the multiple pieces of training data T. Thus, the trained model 60 is a model that is trained, by machine learning, to learn for each of the reference pieces of music a relationship between (i) a combination of audio and an accompaniment pattern P, and (ii) a timbre. The trained model 60 may be referred to as a model that is trained to learn for each of the reference pieces of music a relationship between the input data Xt and the timbre data Zt.

The learning processor 72 transmits the trained model 60 established by the processing described above from the communication device 43 to the information processing system 30 (Sc7). For example, the training processor 72 transmits the multiple variables for the trained model 60 from the communication device 43 to the information processing system 30. The controller 31 of the information processing system 30 stores the trained model 60 received from the machine learning system 40 in the storage device 32. For example, the multiple variables that define the trained model 60 are stored in the storage device 32.

### B: Second Embodiment

A second embodiment will now be described. In the descriptions of the following embodiments, elements having the same functions as in the first embodiment are denoted by the same reference numerals as used for like elements in the description of the first embodiment, and detailed description thereof is omitted, as appropriate.

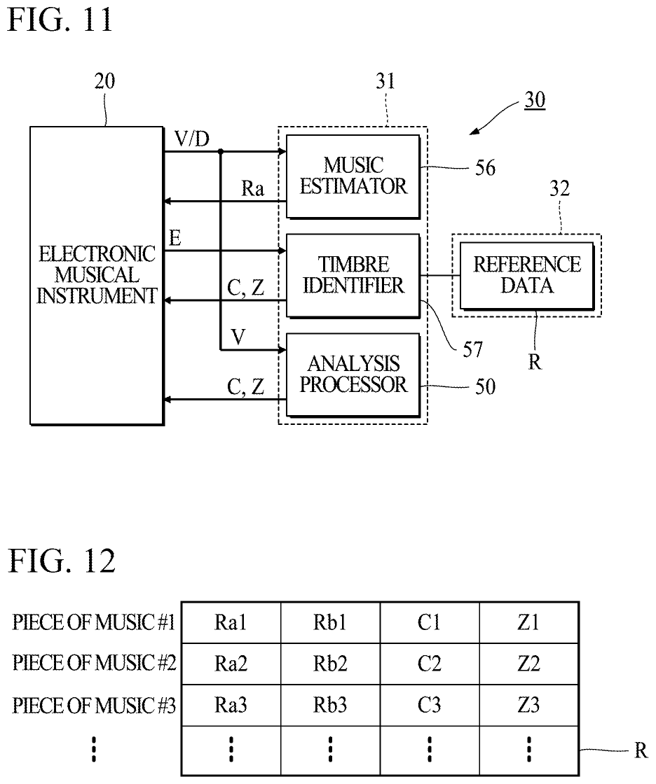

FIG. 11 is a block diagram showing a functional configuration of the information processing system 30 according to the second embodiment. In the first embodiment, the information processing system 30 receives the audio signal V from the electronic musical instrument 20. In the second embodiment, the communication device 33 of the information processing system 30 receives the audio signal V or playing data D from the electronic musical instrument 20.

As in the first embodiment, the audio signal V is a time series of samples representative of a waveform of the audio (instrumental audio) of the target piece of music. The playing data D is time series data indicative of playing of the playing input device 24 by the user U. For example, the playing data D is data in a format compliant with a musical instrument digital interface (MIDI) standard. The playing data D indicates a pitch and duration for each of a plurality of musical notes that constitute a piece of music.

The controller 31 according to the second embodiment executes the program stored in the storage device 32 to function as a music estimator 56 and a timbre identifier 57, in addition to the analysis processor 50 similar to the first embodiment.

The music estimator 56 analyzes the audio signal V or the playing data D received by the communication device 33 from the electronic musical instrument 20 to estimate the target piece of user U-played music. For example, the music estimator 56 specifies a plurality of pieces of music (hereinafter referred to as “candidate pieces of music”) that each have a high probability of corresponding to the target piece of music. To estimate the candidate pieces of music, the music estimator 56 uses reference data R stored in the storage device 32. The audio signal V and the playing data D used for specifying the candidate pieces of music are comprehensively described as data indicative of the playing of the playing input device 24 by the user U.

FIG. 12 is a schematic diagram of the reference data R. As shown in FIG. 12, the reference data R is a database in which music information Ra (Ra1, Ra2, . . . ), comparison data Rb (Rb1, Rb2, . . . ), accompaniment data C (C1, C2, . . . ), and timbre data Z (Z1, Z2, . . . ) are registered for existing pieces of music. The music information Ra includes identification information and information such as a name, etc. The comparison data Rb is time series data indicative of the content. For example, the comparison data Rb as well as the playing data D is data in a format compliant with the MIDI standard. The comparison data Rb indicates a pitch and duration for each of a plurality of musical notes. The accompaniment data C is data indicative of an appropriate accompaniment pattern P. The timbre data Z is data indicative of an appropriate timbre.

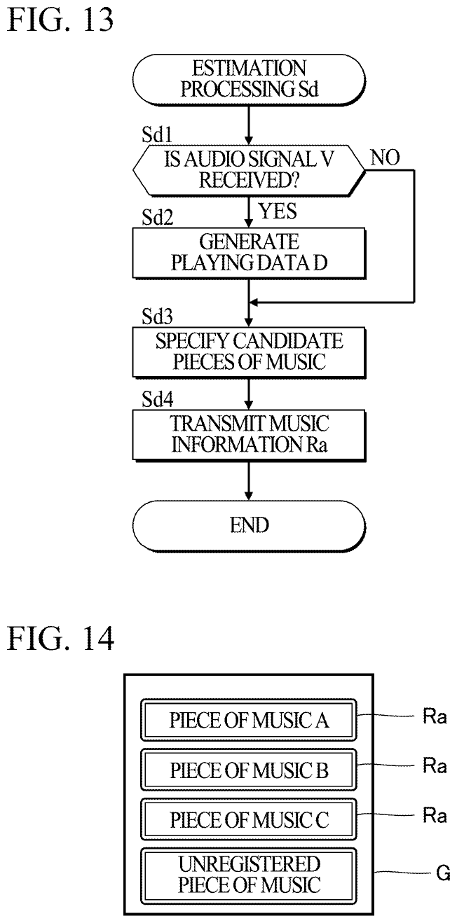

FIG. 13 is a flowchart showing a processing procedure (hereinafter referred to as “estimation processing”) Sd executed by the music estimator 56. For example, the estimation processing Sd starts in response to receipt of the audio signal V or the playing data D transmitted from the electronic musical instrument 20.

When the estimation processing Sd starts, the music estimator 56 determines whether a signal, which has been received from the electronic musical instrument 20 by the communication device 33, is an audio signal V (Sd1). In response to the communication device 33 receiving an audio signal V (Sd1: YES), the music estimator 56 generates the playing data D from the audio signal V (Sd2). The playing data D is time series data indicative of (the content of) playing of a piece of music by the user U. To generate the playing data D from the audio signal V, a known transcription technique may be used. In response to the communication device 33 receiving playing data D (Sd1: NO), generation (Sd2) of playing data D is not executed. As described above, the music estimator 56 acquires the playing data D indicative of the playing of a piece of music by the user U. The playing data D is data generated from the audio signal V received by the communication device 33, or may be data received from the electronic musical instrument 20 by the communication device 33.

The music estimator 56 compares the playing data D with the comparison data Rb registered for each of the pieces of music in the reference data R to specify a predetermined number of candidate pieces of music (Sd3). For example, the music estimator 56 first calculates, for each of the pieces of music registered in the reference data R, a degree of similarity between the comparison data Rb and the playing data D. The music estimator 56 then selects a predetermined number of candidate pieces of music from among the pieces of music in descending order of the degree of similarity. In other words, the music estimator 56 specifies the predetermined number of candidate pieces of music having comparison data Rb similar to the playing data D. Thus, the candidate pieces of music are pieces of music that correspond to a piece of music played by the user U. The music estimator 56 reads the music information Ra for the candidate pieces of music from the reference data R to transmit the music information Ra for the candidate pieces of music from the communication device 33 to the electronic musical instrument 20 (Sd4). In other words, the music information Ra for the candidate pieces of music is transmitted to the electronic musical instrument 20.

The controller 21 of the electronic musical instrument 20 causes the display 26 to display the music information Ra for each of the candidate pieces of music received from the information processing system 30. FIG. 14 is a schematic diagram of a screen (hereinafter referred to as a “selection screen”) G on the display 26. The display 26 displays not only the music information Ra (specifically, the name of a piece of music) for each of the candidate pieces of music, but also text “unregistered piece of music.” The text “unregistered piece of music” means that a corresponding piece of music is not registered in the reference data R. The unregistered piece of music is, for example, a piece of music created by the user U. The user U operates the operation device 25 to select the target piece of music from the selection screen G. The controller 21 transmits selection instructions E, which indicate the target piece of music selected by the user U, from the communication device 23 to the information processing system 30.

For example, when the target piece of music is an existing candidate piece of music, the user U selects the candidate piece of music from the selection screen G. In response to the user U selecting the candidate piece of music, the controller 21 transmits selection instructions E indicative of the candidate piece of music from the communication device 33 to the information processing system 30. For example, the selection instructions E including the music information Ra for the candidate piece of music are transmitted to the information processing system 30. On the other hand, when the target piece of music is a piece of music other than the candidate piece of music (for example, a piece of music created by the user U), the user U selects an unregistered piece of music from the selection screen G. In response to the user U selecting an unregistered piece of music, the controller 21 transmits selection instructions E, which indicates that the target piece of music is an unregistered piece of music, from the communication device 33 to the information processing system 30.

For existing candidate pieces of music, the accompaniment data C and the timbre data Z are registered in reference data R, whereas for an unregistered piece of music such as a piece of music created by the user U, neither accompaniment data C nor timbre data Z is registered in reference data R. In a case where the target piece of music is a registered candidate piece of music in the reference data R, the timbre identifier 57 shown in FIG. 11 specifies the accompaniment data C and the timbre data Z for the candidate piece of music using the reference data R. For example, the timbre identifier 57 acquires the accompaniment data C and the timbre data Z registered for the target piece of music from the storage device 32. On the other hand, in a case where the target piece of music is an unregistered piece of music, the analysis processor 50 according to the second embodiment analyzes the audio signal V to generate the accompaniment data C and the timbre data Z for the target piece of music. The configuration and the operation of the analysis processor 50 are substantially the same as that of the first embodiment.

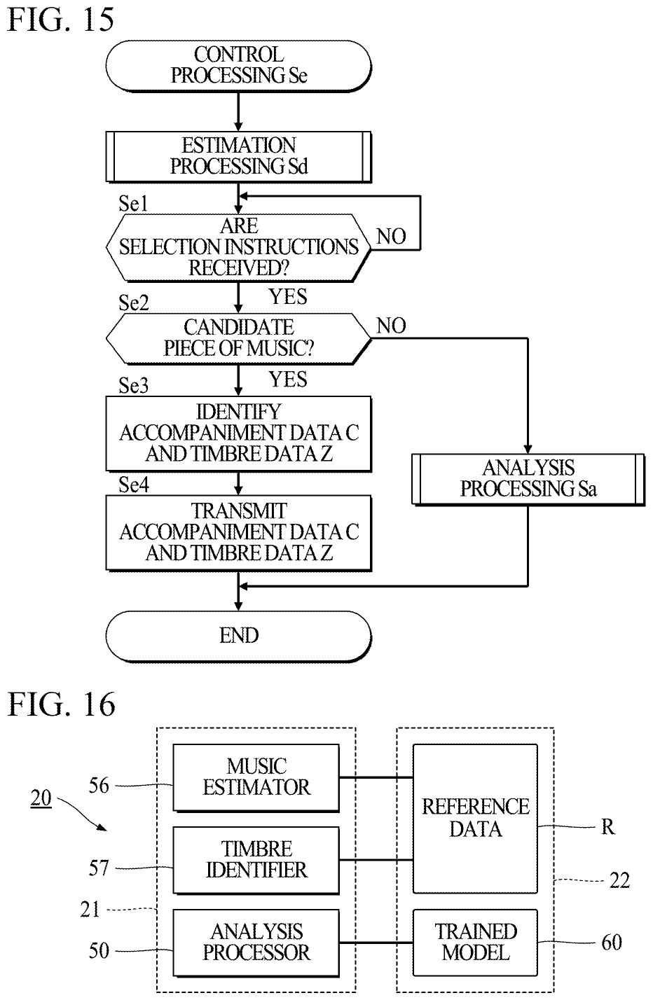

FIG. 15 is a flowchart showing a processing procedure (hereinafter referred to as “control processing”) Se executed by the controller 31 of the information processing system 30 according to the second embodiment. For example, the control processing Se starts in response to receipt of the audio signal V or the playing data D.

When the control processing Se starts, the music estimator 56 executes the estimation processing Sd shown in FIG. 13. Thus, the music estimator 56 notifies the electronic musical instrument 20 of the predetermined number of candidate pieces of music each of which has the comparison data Rb similar to the playing data D. In response to completion of the estimation processing Sd, the controller 31 waits until the communication device 33 receives selection instructions E from the electronic musical instrument 20 (Se1: NO).

In response to the communication device 33 receiving selection instructions E (Se1: YES), the controller 31 determines whether the selection instructions E indicate a candidate piece of music (Se2). The determination described above is processing to determine whether the target piece of music is registered in the reference data R. When the selection instructions E indicate a candidate piece of music (Se2: YES), the target piece of music is registered in the reference data R. When the selection instructions E indicate an unregistered piece of music (Se2: NO), the target piece of music is not registered in the reference data R. When the target piece of music is not registered in the reference data R, accompaniment data C and timbre data Z are not specified by using the reference data R.

When the selection instructions E indicate a candidate piece of music (Se2: YES), the timbre identifier 57 identifies the accompaniment data C and the timbre data Z for the candidate piece of music from the reference data R (Se3). The timbre identifier 57 transmits the accompaniment data C and the timbre data Z for the candidate piece of music from the communication device 33 to the electronic musical instrument 20 (Se4). The electronic musical instrument 20 executes the playing processing Sb in FIG. 7 by using the accompaniment data C and the timbre data Z received from the information processing system 30.

On the other hand, when the selection instructions E indicate an unregistered piece of music (Se2: NO), the analysis processor 50 executes the analysis processing Sa in FIG. 6 by using the trained model 60. Thus, the analysis processor 50 analyzes the audio signal V received from the electronic musical instrument 20 to generate the accompaniment data C and the timbre data Z. The analysis processor 50 transmits the accompaniment data C and the timbre data Z from the communication device 33 to the electronic musical instrument 20 (Sa3 and Sa5). The electronic musical instrument 20 executes the playing processing Sb in FIG. 7 by using the accompaniment data C and the timbre data Z received from the information processing system 30.

As described above, in the second embodiment, when the timbre (timbre data Z) for the target piece of music is registered in the reference data R, the timbre identifier 57 identifies the timbre data Z by using the reference data R. When the timbre for the target piece of music is not registered in the reference data R, the analysis processor 50 generates the timbre data Z by using the trained model 60. In other words, when the timbre appropriate for the target piece of music is registered in the reference data R, timbre data Z indicative of the registered timbre is generated. Accordingly, the timbre appropriate for a registered piece of music is identified, and a timbre appropriate for an unregistered piece of music (for example, a new piece of music created by the user U) can be identified. For the registered target piece of music, the accompaniment data C and the timbre data Z are identified from the reference data R; accordingly, the analysis processing Sa is not required for the registered target piece of music. Therefore, an advantage is obtained in that a load required for the analysis processing Sa is reduced.

### C: Third Embodiment

FIG. 16 is a block diagram showing a functional configuration of the electronic musical instrument 20 according to a third embodiment. In the second embodiment, the information processing system 30 includes the analysis processor 50, the music estimator 56, and the timbre identifier 57. In the third embodiment, the electronic musical instrument 20 includes the analysis processor 50, the music estimator 56, and the timbre identifier 57. The above components are implemented by the controller 21 that executes the program stored in the storage device 22.

The specific configuration and operation of each of the components (the music estimator 56, the timbre identifier 57, and the analysis processor 50) shown in FIG. 16 are substantially the same as those of the first embodiment or as those of the second embodiment. For example, the music estimator 56 analyzes either the audio signal V provided from the signal providing device 10 or the playing data D corresponding to the playing of the playing input device 24 to specify the candidate pieces of music that have a high probability of corresponding to the target piece of music played by the user U. The music estimator 56 causes the display 26 to display the selection screen G, which indicates the music information Ra for each of the candidate pieces of music, and receives an operation from the user U.

When the target piece of music is a candidate piece of music registered in the reference data R, the timbre identifier 57 identifies the accompaniment data C and the timbre data Z for the target piece of music by using the reference data R. The reference data R is stored in the storage device 22. The reference data R is used not only for the estimation of the candidate pieces of music by the music estimator 56, but also for the processing by the timbre identifier 57.

When the target piece of music is an unregistered piece of music, the analysis processor 50 analyzes the audio signal V to generate the accompaniment data C and the timbre data Z for the target piece of music. The analysis processor 50 uses the trained model 60 to execute the analysis processing Sa. The trained model 60 is stored in the storage device 22. In other words, the trained model 60 generated by the machine learning system 40 is transmitted to the electronic musical instrument 20. The configuration of the trained model 60 is substantially the same as that of the first embodiment.

As in the first embodiment, the audio source 27 generates the playing signal A representative of audio obtained by mixing the accompaniment audio, which corresponds to the accompaniment pattern P indicated by the accompaniment data C, together with the audio (instrumental audio) with the timbre indicated by the timbre data Z. The playing signal A is provided for the sound emitting device 28. Accordingly, the audio source 27 and the sound emitting device 28 function as a reproduction device 29. The reproduction device 29 is configured not only to reproduce the audio with the timbre indicated by the timbre data Z, in accordance with the playing of a piece of music by the user U, but also to reproduce the accompaniment audio, which corresponds to the accompaniment pattern P indicated by the accompaniment data C.

As will be understood from the above description, the third embodiment provides the same effects as those of the first and second embodiments. The electronic musical instrument 20, which includes the analysis processor 50, the music estimator 56, and the timbre identifier 57, is shown in FIG. 16; however, the music estimator 56 and the timbre identifier 57 may be omitted from the electronic musical instrument 20.

### D: Fourth Embodiment

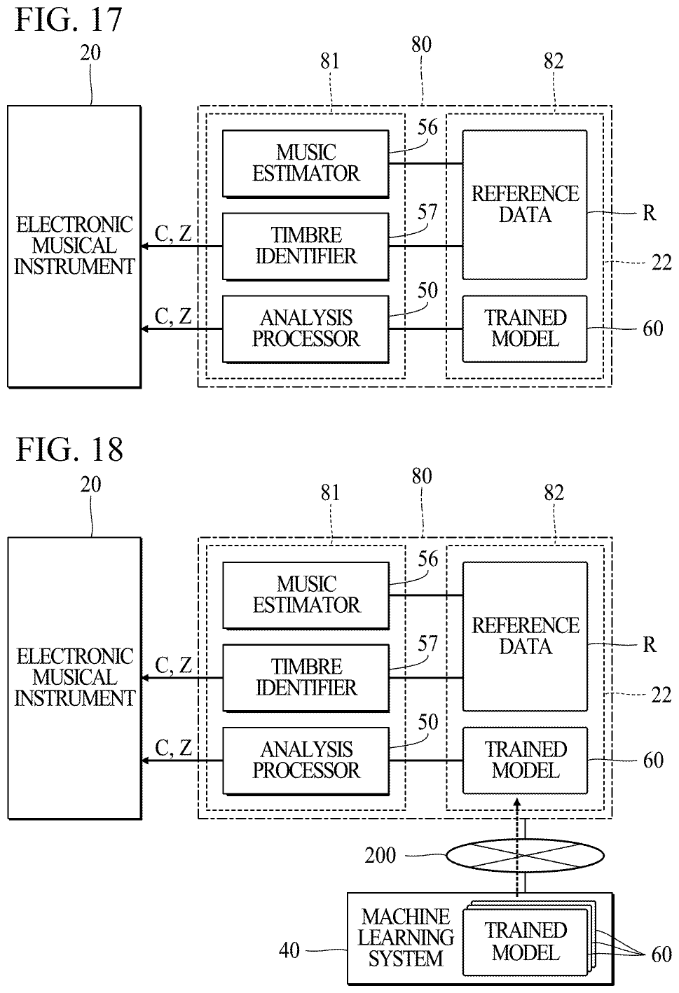

FIG. 17 is a block diagram showing a configuration of the playing system 100 according to a fourth embodiment. The playing system 100 includes the electronic musical instrument 20 and an information device 80. The information device 80 is a device such as a smartphone or a tablet terminal. The information device 80 may be connected to the electronic musical instrument 20 either by wire or wirelessly.

The information device 80 is implemented by a computer system that includes a controller 81 and a storage device 82. The controller 81 is constituted of one or more processors configured to control components of the information device 80. The controller 81 may be constituted of one or more types of processors such as a CPU, an SPU, a DSP, an FPGA, or an ASIC. The storage device 82 includes one or more memories configured to store a program executed by the controller 81 and a variety of types of data used by the controller 81. The storage device 82 may be constituted of a known recording medium such as a magnetic recording medium or a semiconductor recording medium. Alternatively, the storage device 82 may be constituted of a combination of different types of recording media. The storage device 82 may be a portable recording medium that is detachable from the information device 80. The storage device 82 may be a recording medium (for example, a cloud storage server) that is accessible to the controller 81 via the communication network 200.

The controller 81 executes the program stored in the storage device 82 to function as the analysis processor 50, the music estimator 56, and the timbre identifier 57. The configuration and operation of each of the analysis processor 50, the music estimator 56, and the timbre identifier 57 are substantially the same as those of the first, second, and third embodiments. The reference data R, which is used not only by the music estimator 56 but also by the timbre identifier 57, and the trained model 60 used by the analysis processor 50 are stored in the storage device 82.

The accompaniment data C and the timbre data Z specified by either the analysis processor 50 or the music estimator 56 is transmitted to the electronic musical instrument 20. As in the first embodiment, the audio source 27 of the electronic musical instrument 20 generates the playing signal A representative of the audio obtained by mixing the accompaniment audio, which corresponds to the accompaniment pattern P indicated by the accompaniment data C, with the audio (instrumental audio) that has the timbre indicated by the timbre data Z. The playing signal A is provided to the sound emitting device 28.

As will be understood from the above description, the fourth embodiment provides the same effects as those of the first, second, and third embodiments. The information device 80, which includes the analysis processor 50, the music estimator 56, and the timbre identifier 57, is shown in FIG. 17; however, the music estimator 56 and the timbre identifier 57 may be omitted from the information device 80.

In the fourth embodiment, for example, the trained model 60 established by the machine learning system 40 is transferred to the information device 80, and the trained model 60 is stored in the storage device 82. In the configuration described above, an authentication processor configured to authenticate a user (a user registered in advance) of the information device 80 may be included in the machine learning system 40. When the user is authenticated by the authentication processor, the trained model 60 is automatically transferred to the information device 80 (i.e., without requiring instructions from the user).

### E: Fifth Embodiment

FIG. 18 is a block diagram showing a configuration of the playing system 100 according to a fifth embodiment. As in the fourth embodiment, the playing system 100 includes the electronic musical instrument 20 and the information device 80. The configurations of the electronic musical instrument 20 and the information device 80 are substantially the same as those of the fourth embodiment.

The machine learning system 40 stores multiple trained models 60 that correspond to different types of electronic musical instrument 20. A number of timbres that can be produced by the electronic musical instruments 20 (specifically, audio sources 27) differs depending on the type of electronic musical instrument 20. The trained model 60, which corresponds to a type of electronic musical instrument 20, outputs the timbre data Z indicative of timbre that can be produced by the type of electronic musical instrument 20. The trained model 60, which corresponds to a type of electronic musical instrument 20, does not output timbre data Z indicative of a timbre that cannot be produced by the type of electronic musical instrument 20. In the learning processing Sc to establish a trained model 60 for a type of electronic musical instrument 20, training data T is used that includes the timbre data Zt indicative of a timbre that can be produced by the type of electronic musical instrument 20. For example, a set of training data T is prepared for each of the types of electronic musical instrument 20 (i.e., for each timbre that can be produced). The trained model 60 is established through the learning processing Sc for each of the types of electronic musical instrument 20.

The information device 80 selectively acquires one of the trained models 60 included in the machine learning system 40 via the communication network 200. For example, the information device 80 acquires one of the trained models 60, which corresponds to the type of electronic musical instrument 20 connected to the information device 80, from the machine learning system 40. The trained model 60 acquired from the machine learning system 40 is stored in the storage device 82 and is used for the analysis processing Sa by the analysis processor 50. The specific procedure of the analysis processing Sa is substantially the same as that of the respective embodiments described above.

As will be understood from the above description, the fifth embodiment provides the same effects as those of the first, second, and third embodiments. In the fifth embodiment, the trained model 60 is established for each of the types of electronic musical instrument 20. Accordingly, compared to a configuration in which a common trained model 60 is used regardless of a type of electronic musical instrument 20, the fifth embodiment has an advantage in that the timbre data Z appropriate for each of the types of electronic musical instrument 20 can be estimated with high accuracy. The information processing system 30 according to the first embodiment or to the second embodiment, the electronic musical instrument 20 according to the third embodiment, the information device 80 according to the fourth embodiment or to the fifth embodiment are examples of an “information processing system.”

### F: Modifications

The following are examples of modifications of the embodiments described above. Two or more modifications freely selected from the following modifications may be combined as long as no conflict arises from such combination.

(1) The analysis processor 50 may generate the timbre data Z for each time period (hereinafter referred to as “unit time period”) that has a predetermined length on the time axis. The first acquirer 51 generates the audio data F for each unit time period of the audio signal V. The generator 53 generates, for each of the unit time periods, the timbre data Z from the input data X, which includes the audio data F in the unit time period and the accompaniment data C specified by the second acquirer 52.

From pieces of timbre data Z that correspond to different unit time periods, the controller 21 or the controller 31 may identify a timbre to be set in the audio source 27. For example, from the timbre data Z, a most frequently occurring timbre may be selected. A predetermined number of timbres may be displayed to the user U in descending order of occurrence as specified by the generator 53, and the user U may select one timbre to be set in the audio source 27.

(2) The first acquirer 51 according to the first embodiment generates the audio data F. Alternatively, the first acquirer 51 may receive from the electronic musical instrument 20, the audio data F generated from the audio signal V by the electronic musical instrument 20. Thus, the acquisition of the audio data F by the first acquirer 51 includes both the generation of the audio data F and the reception of the audio data F. The second acquirer 52 according to the first embodiment generates the accompaniment data C. Alternatively, the second acquirer 52 may receive from the electronic musical instrument 20, the accompaniment data C generated from the audio signal V by the electronic musical instrument 20. Thus, the acquisition of the accompaniment data C by the second acquirer 52 includes both the generation of the accompaniment data C and the reception of the accompaniment data C. The first acquirer 51 or the second acquirer 52 may be included in the electronic musical instrument 20.

(3) In each of the foregoing embodiments, an example of the timbre data Z indicative of a timbre is explained. However, the timbre data Z is not limited to the example described above. For example, the timbre data Z may be data indicative of probability distribution for different timbres. For example, the timbre data Z may indicate, for each timbre, an average and variance of the probability distribution represented by normal distribution. The controller 21 or the controller 31 specifies one timbre having a maximum likelihood from multiple pieces of probability distribution for the different timbres indicated by the timbre data Z. The timbre data Z, which indicates the probability distribution for a timbre, corresponds to data indicative of a timbre.

(4) In each of the foregoing embodiments, the generator 53 generates the timbre data Z from the audio data F and the accompaniment data C. Alternatively, the generator 53 may generate the timbre data Z from only the audio data F. Thus, the accompaniment data C may be omitted. As will be understood from the above description, the trained model 60 is comprehensively described as a model that is trained, by machine learning, to learn, for each reference piece of the plurality of reference pieces of music a relationship between audio (audio data Ft) and a timbre (timbre data Zt).

(5) In each of the foregoing embodiments, an example of the trained model 60 is a deep neural network. However, the trained model 60 is not limited to a deep neural network. A statistical estimation model, such as Hidden Markov Model (HMM) or Support Vector Machine (SVM) may be used as trained model 60. Examples will be described below.

### (5-1) HMM

HMM is a statistical estimation model in which hidden states are connected to each other. Each of the hidden states of the HMM indicates one of the different timbres (i.e., timbre data Z). In each of the hidden states, a piece of audio data F indicative of a feature of the timbre indicated by the hidden state is generated. As in each of the foregoing embodiments, the piece of audio data F is data indicative of a time series of frequency characteristics such as MFCC, MSLS, or CQT, for example. The hidden states included in the HMM correspond to different time periods (hereinafter referred to as “processing time periods”) for divided signals obtained by dividing the audio signal V on the time axis. Each of the processing time periods is a time period obtained by dividing a time period of the target piece of music by a unit of a predetermined number (one or more) of measures, for example.

The first acquirer 51 generates, for each of the processing time periods, the audio data F from part of the audio signal V (divided signal) that is included in the processing time period. The generator 53 inputs a time series of pieces of audio data F generated for the different processing time periods into the trained model 60 including the HMM. Under condition that the time series of pieces of audio data F is observed, the generator 53 estimates a time series of timbre data Z having the maximum likelihood by using the HMM. Thus, for each of the processing time periods for the audio signal V, the timbre data Z is outputted from the HMM. To estimate the time series of timbre data Z, dynamic programming such as Viterbi algorithm is used, for example.

The HMM is established by supervised machine learning (learning processing Sc) using multiple pieces of training data T including the timbre data Zt. In the learning processing Sc, transitional probability and output probability for each of the hidden states are repeatedly updated so that a time series of pieces of timbre data Z having the maximum likelihood is output for a time series of pieces of audio data F.

### (5-2) SVM

An SVM is provided for every combination for selecting two timbres from among multiple timbres. The SVM, which corresponds to a combination of two timbres, establishes a hyperplane in multi-dimensional space by machine learning (learning processing Sc). The hyperplane is a boundary surface that divides a first space from a second space. The first space includes distributed pieces of input data X that correspond to one of the two timbres. The second space includes distributed pieces of input data X that correspond to the other of the two timbres. The trained model 60 is constituted of multiple SVMs (multi-class SVM) that correspond to different timbre combinations.

The generator 53 inputs the input data X, which includes the audio data F and the accompaniment data C, into each of the multiple SVMs. The SVM, which corresponds to each of the combinations, selects one of the two timbres corresponding to the combination based on whether the input data X is included in the first space or in the second space. Thus, the multiple SVMs corresponding to the different combinations each select one of the two timbres. The generator 53 generates timbre data Z indicative of one timbre, which has the largest number of selections by the respective multiple SVMs, among the different timbres.

As will be understood from the above description, regardless of the type of the trained model 60, the generator 53 functions as an element configured to input the input data X into the trained model 60 to cause the trained model 60 to output the timbre data Z indicative of the timbre appropriate for the target piece of music.

(6) In each of the foregoing embodiments, an example of the learning processing Sc is supervised machine learning using the multiple pieces of training data T. However, the trained model 60 may be established by unsupervised machine learning in which the multiple pieces of training data T are not required. Alternatively, the trained model 60 may be established by reinforcement learning in which cumulative reward is maximized. In an example of the reinforcement learning, the training processor 72 sets a reward function to “+1” when the timbre data Zt, which is output from the provisional model 65 receiving the input data Xt of each of the multiple pieces of training data T, corresponds to the timbre data Z of the piece of training data T. The training processor 72 sets the reward function to “−1” when the timbre data Zt does not correspond to the timbre data Z. The training processor 72 establishes the trained model 60 by repeatedly updating the multiple variables for the provisional model 65 so that the sum of the reward functions set for the multiple pieces of training data T is maximized. In an example of the unsupervised machine learning, known clustering may be used.

(7) In each of the foregoing embodiments, the machine learning system establishes the trained model 60. However, the functions (the training data acquirer 71 and the training processor 72) of the machine learning system 40 may be included in the information processing system 30. Alternatively, the functions (the training data acquirer 71 and the training processor 72) of the machine learning system 40 may be included in the electronic musical instrument 20 according to the third embodiment, or may be included in the information device 80 according to the fourth embodiment.

(8) In each of the foregoing embodiments, the timbre data Z is generated from the input data X corresponding to the audio signal V by using the trained model 60 that has been trained to learn a relationship between the input data X for the reference pieces of music and the timbre data Z for the reference pieces of music. However, the configuration and the method of generating the timbre data Z from the input data X are limited to those of the foregoing embodiments. For example, the generator 53 may generate the timbre data Z by using a reference table in which multiple pieces of timbre data Z have a one-to-one correspondence with multiple pieces of input data X. The reference table is a data table in which associations between the input data X and the timbre data Z are registered. The reference table is, for example, stored in the storage device 32. The generator 53 of the analysis processor 50 searches the reference table for a piece of input data X that is identical to or close to the input data X generated from the audio signal V. The generator 53 acquires a piece of timbre data Z, which corresponds to the piece of input data X that is identical to or close to the input data X, among the multiple pieces of timbre data Z in the reference table. By the configuration described above, it is possible to identify a timbre appropriate for a new piece of music as in the foregoing embodiments.

(9) The functions (the analysis processor 50, the music estimator 56, and the timbre identifier 57) described in the foregoing embodiments are implemented by cooperation of one or more processors, which include the controller (21, 31, or 71), and a program stored in the storage device (22, 32, or 72). The program may be provided in a form stored in a computer-readable recording medium and the program may be installed in a computer. The recording medium may be a non-transitory recording medium. An example of the non-transitory recording medium is an optical recording medium (an optical disk) such as a compact disk read-only memory (CD-ROM). The non-transitory recording medium may also include a recording medium of any known form, such as a semiconductor recording medium or a magnetic recording medium. The non-transitory recording medium, which includes any recording medium except for a transitory, propagating signal, does not exclude a volatile recording medium. The non-transitory recording medium may be a storage apparatus in a distribution apparatus that stores a computer program for distribution via a communication network.

### G: Supplemental Notes

The following configurations are derivable from the foregoing embodiments.

An information processing system according to one aspect (first aspect) includes: at least one memory configured to store instructions; and at least one processor configured to implement the instructions to: acquire first audio data indicative of audio of a target piece of music; and cause a trained model to output first timbre data indicative of a timbre appropriate for the target piece of music by inputting input data into the trained model, the input data including the first audio data, in which the trained model is trained to learn a relationship between second audio data indicative of audio and second timbre data indicative of a timbre for each reference piece of a plurality of reference pieces of music. According to this aspect, the input data, which includes the first audio data indicative of the audio of the target piece of music, is input into the trained model, thereby generating the first timbre data indicative of the timbre appropriate for the target piece of music. Therefore, it is possible to identify a timbre appropriate for a new piece of music, for example.

The audio indicated by the first audio data is, for example, sound emitted from a sound source, such as a musical instrument, during playing of a piece of music. The “playing” includes not only playing of a musical instrument, but also singing by a singer. The “first timbre data” is any data indicative of the timbre appropriate for the target piece of music. For example, identification information for identifying one timbre is assumed as first timbre data. However, the first timbre data is not limited to data that explicitly specifies one timbre. For example, the concept of the first timbre data may include data indicative of probability (likelihood) for each of the timbres, or data indicative of a probability distribution (e.g., average and variance) for each of the different timbres.

The timbre “appropriate” for the target piece of music means timbre that is musically appropriate for the target piece of music. For example, the timbre appropriate for the target piece of music may include a timbre appropriate for the target piece of music such as a timbre for a melody of the target piece of music, and a timbre appropriate for musical expression of the target piece of music, etc.

The “trained model” is a statistical estimation model established by supervised machine learning using multiple pieces of training data, for example. Each of the multiple pieces of training data is, for example, a combination of training input data and training timbre data (ground truth).

In a specific example (second aspect) of the first aspect, the at least one processor is further configured to implement the instructions to acquire first accompaniment data indicative of an accompaniment pattern that corresponds to the target piece of music, and the trained model is trained to learn a relationship between the second audio data, second accompaniment data indicative of an accompaniment pattern, and the second timbre data for each reference piece of the plurality of reference pieces of music. The input data includes the first audio data and the first accompaniment data. In this aspect, the input data, which includes both the first audio data indicative of the audio of the target piece of music and the first accompaniment data indicative of the accompaniment pattern corresponding to the target piece of music, is input into the trained model. Accordingly, it is possible to identify a timbre appropriate for a combination of the audio of the target piece of music and the accompaniment pattern of the target piece of music.

The “accompaniment pattern” is an audio signal representative of accompaniment audio of the target piece of music. The “first accompaniment data” may be identification information for identifying an accompaniment pattern among different accompaniment patterns. The first accompaniment data indicates either an accompaniment pattern automatically estimated by analysis of the audio of the target piece of music or an accompaniment pattern specified by the user, for example.

In a specific example (third aspect) of the second aspect, the trained model includes: a first model configured to generate first data from the first audio data, the first data being indicative of a feature related to the audio of the target piece of music; a second model configured to generate second data from the first accompaniment data, the second data being indicative of a feature of the accompaniment pattern that corresponds to the target piece of music; and a third model configured to generate the first timbre data from intermediate data that includes the first data and the second data.

In a specific example (fourth aspect) of any of the first, second, and third aspects, the at least one processor is further configured to implement the instructions to: in a case where the timbre appropriate for the target piece of music is included in a plurality of timbres appropriate for a plurality of pieces of music, the plurality of timbres and the plurality of pieces of music being registered in reference data, identify the first timbre data using the reference data; and in a case where no timbre for the target piece of music is registered in the reference data, generate the first timbre data using the trained model. In this aspect, in a case where the timbre appropriate for the target piece of music is registered in the reference data, the first timbre data indicative of the registered timbre is generated. Thus, it is possible to identify a timbre appropriate for an unregistered piece of music (for example, a new piece of music created by a user), and to generate timbre data indicative of a timbre appropriate for a registered piece of music.

In a specific example (fifth aspect) of the fourth aspect, the at least one processor is further configured to implement the instructions to: estimate, from the plurality of pieces of music registered in the reference data, candidate pieces of music that correspond to a piece of user-played music; and identify, in a case where one of the candidate pieces of music is selected as the target piece of music, the timbre data corresponding to the target piece of music using the reference data. In this aspect, in a case where one of the candidate pieces of music is selected as the target piece of music, the first timbre data corresponding to the selected target piece of music is identified by using the reference data. Accordingly, it is possible to identify first timbre data appropriate for the piece of user-played target music.

In a specific example (sixth aspect) of the fifth aspect, the at least one processor is further configured to implement the instructions to generate the first timbre data using the trained model in a case where a piece of music other than the candidate pieces of music is selected as the target piece of music. According to this aspect, it is possible to generate first timbre data appropriate for an unregistered piece of music other than the candidate pieces of music.

In a specific example (seventh aspect) of the fifth or sixth aspect, comparison data is registered in the reference data, the comparison data being indicative of content of the plurality of pieces of music, and the at least one processor is further configured to implement the instructions to estimate the candidate pieces of music by comparing the comparison data with data indicative of the piece of user-played music. According to this aspect, it is possible to estimate the candidate pieces of music using the comparison data registered in the reference data together with the timbre data.

In a specific example (eighth aspect) of any of the first through seventh aspects, the first audio data includes data indicative of a time series of frequency characteristics related to the audio of the target piece of music. The time series of frequency characteristics related to the audio of the target piece of music may be an intensity spectrum, such as an amplitude spectrum, or a power spectrum, an MFCC, a MSLS, or a CQT.

An electronic musical instrument according to one aspect (ninth aspect) of the present disclosure includes: at least one memory configured to store instructions; and at least one processor configured to implement the instructions to: acquire first audio data indicative of audio of a target piece of music; cause a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality of reference pieces of music; and cause a sound emitting device to emit sound with a timbre corresponding to the first timbre data in accordance with playing of a piece of music. The “playing” is, for example, playing of a plurality of keys of a keyboard.

In a specific example (tenth aspect) of the ninth aspect, the electronic musical instrument further includes a keyboard with a plurality of keys corresponding to different pitches, and the at least one processor is further configured to implement the instructions to cause the sound emitting device to emit the sound with both the timbre corresponding to the timbre data and a pitch corresponding to a played key among the plurality of keys. In this aspect, the electronic musical instrument is a keyboard instrument equipped with a keyboard. According to this aspect, it is possible to reproduce audio that has both a pitch corresponding to a played key and the timbre corresponding to the first timbre data.

A computer-implemented information processing method according to one aspect (eleventh aspect) of the present disclosure includes: acquiring first audio data indicative of audio of a target piece of music; and causing a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality of reference pieces of music. The information processing method according to the eleventh aspect may include each of the foregoing aspects (second through eighth aspects) for use in the information processing system.

A non-transitory computer-readable recording medium according to one aspect of the present disclosure is a non-transitory computer-readable recording medium configured to store a program executable by at least one processor to performed an information processing method, and the method includes: acquiring first audio data indicative of audio of a target piece of music; and causing a trained model to output first timbre data indicative of a timbre appropriate for the target piece of music by inputting input data into the trained model, the input data including the first audio data, and the trained model is trained to learn a relationship between second audio data indicative of audio and second timbre data indicative of a timbre for each reference piece of a plurality of reference pieces of music.

### DESCRIPTION OF REFERENCE SIGNS

100 . . . playing system, 10 . . . signal providing device, 20 . . . electronic musical instrument, 21, 31, 41, 81 . . . controller, 22, 32, 42, 82 . . . storage device, 23, 33, 43 . . . communication device, 24 . . . playing input device, 25 . . . operation device, 26 . . . display, 27 . . . audio source, 28 . . . sound emitting device, 29 . . . reproduction device, 30 . . . information processing system, 40 . . . machine learning system, 50 . . . analysis processor, 51 . . . first acquirer, 52 . . . second acquirer, 53 . . . generator, 56 . . . music estimator, 57 . . . timbre identifier, 60 . . . trained model, 61 . . . first model, 62 . . . second model, 63 . . . third model, 65 . . . provisional model, 71 . . . training data acquirer, 72 . . . training processor, 80 . . . information device.

What is claimed is:

1. An information processing system comprising:
at least one memory configured to store instructions; and
at least one processor configured to implement the instructions to:
acquire first audio data indicative of audio of a target piece of music; and
cause a trained model to output first timbre data indicative of a timbre appropriate for the target piece of music by inputting input data into the trained model, the input data including the first audio data, wherein the trained model is trained to learn a relationship between second audio data indicative of audio and second timbre data indicative of a timbre for each reference piece of a plurality of reference pieces of music.

2. The information processing system according to claim 1, wherein:
the at least one processor is further configured to implement the instructions to acquire first accompaniment data indicative of an accompaniment pattern that corresponds to the target piece of music,
the trained model is trained to learn a relationship between the second audio data, second accompaniment data indicative of an accompaniment pattern, and the second timbre data for each reference piece of the plurality of reference pieces of music, and
the input data includes the audio data and the accompaniment data.

3. The information processing system according to claim 2, wherein the trained model includes:
a first model configured to generate first data from the first audio data, the first data being indicative of a feature related to the audio of the target piece of music;
a second model configured to generate second data from the first accompaniment data, the second data being indicative of a feature of the accompaniment pattern that corresponds to the target piece of music; and
a third model configured to generate the first timbre data from intermediate data that includes the first data and the second data.

4. The information processing system according to claim 1, wherein the at least one processor is further configured to implement the instructions to:
in a case where the timbre appropriate for the target piece of music is included in a plurality of timbres appropriate for a plurality of pieces of music, the plurality of timbres and the plurality of pieces of music being registered in reference data, identify the first timbre data using the reference data; and
in a case where no timbre appropriate for the target piece of music is registered in the reference data, generate the first timbre data using the trained model.

5. The information processing system according to claim 4, wherein the at least one processor is further configured to implement the instructions to:
estimate, from the plurality of pieces of music registered in the reference data, candidate pieces of music that correspond to a piece of user-played music; and
identify, in a case where one of the candidate pieces of music is selected as the target piece of music, the first timbre data corresponding to the target piece of music using the reference data.

6. The information processing system according to claim 5, wherein the at least one processor is further configured to implement the instructions to generate the first timbre data using the trained model in a case where a piece of music other than the candidate pieces of music is selected as the target piece of music.

7. The information processing system according to claim 5, wherein:
comparison data is registered in the reference data, the comparison data being indicative of content of the plurality of pieces of music, and
the at least one processor is further configured to implement the instructions to estimate the candidate pieces of music by comparing the comparison data with data indicative of the piece of user-played music.

8. The information processing system according to claim 1, wherein the first audio data includes data indicative of a time series of frequency characteristics related to the audio of the target piece of music.

9. An electronic musical instrument comprising:
at least one memory configured to store instructions; and
at least one processor configured to implement the instructions to:
acquire first audio data indicative of audio of a target piece of music;
cause a trained model to output first timbre data indicative of a timbre appropriate for the target piece of music by inputting input data into the trained model, the input data including the first audio data, wherein the trained model is trained to learn a relationship between second audio data indicative of audio and second timbre data indicative of a timbre for each reference of a plurality of reference pieces of music; and
cause a sound emitting device to emit sound with a timbre corresponding to the first timbre data in accordance with playing of a piece of music.

10. The electronic musical instrument according to claim 9, further comprising a keyboard with a plurality of keys corresponding to different pitches,
wherein the at least one processor is further configured to implement the instructions to cause the sound emitting device to emit the sound with both the timbre corresponding to the first timbre data and a pitch corresponding to a played key among the plurality of keys.

11. A computer-implemented information processing method comprising:
acquiring first audio data indicative of audio of a target piece of music; and
causing a trained model to output first timbre data indicative of a timbre appropriate for the target piece of music by inputting input data into the trained model, the input data including the first audio data, wherein the trained model is trained to learn a relationship between second audio data indicative of audio and second timbre data indicative of a timbre for each reference piece of a plurality of reference pieces of music.

12. The information processing method according to claim 11, further comprising acquiring first accompaniment data indicative of an accompaniment pattern that corresponds to the target piece of music,
wherein:
the trained model is further trained to learn a relationship between the second audio data, second accompaniment data indicative of an accompaniment pattern, and the second timbre data for each reference piece of the plurality of reference pieces of music, and
the input data includes the first audio data and the first accompaniment data.

13. The information processing method according to claim 12, wherein the trained model includes:
a first model configured to generate first data from the first audio data, the first data being indicative of a feature related to the audio of the target piece of music;
a second model configured to generate second data from the first accompaniment data, the second data being indicative of a feature of the accompaniment pattern that corresponds to the target piece of music; and
a third model configured to generate the first timbre data from intermediate data that includes the first data and the second data.

14. The information processing method according to claim 11, further comprising:
in a case where the timbre appropriate for the target piece of music is included in a plurality of timbres appropriate for a plurality of pieces of music, the plurality of timbres and the plurality of pieces of music being registered in reference data, identifying the first timbre data using the reference data; and
in a case where no timbre appropriate for the target piece of music is registered in the reference data, generating the first timbre data using the trained model.

15. The information processing method according to claim 14, further comprising estimating, from the plurality of pieces of music registered in the reference data, candidate pieces of music that correspond to a piece of user-played music,
wherein the identifying of the first timbre data includes identifying, in a case where one of the candidate pieces of music is selected as the target piece of music, the first timbre data corresponding to the target piece of music using the reference data.

16. The information processing method according to claim 15, wherein the generating of the first timbre data includes generating the first timbre data using the trained model in a case where a piece of music other than the candidate pieces of music is selected as the target piece of music.

17. The information processing method according to claim 15, wherein:
comparison data is registered in the reference data, the comparison data being indicative of content of the plurality of pieces of music, and
the estimating of the candidate pieces of music includes estimating the candidate pieces of music by comparing the comparison data with data indicative of the piece of user-played music.

18. The information processing method according to claim 11, wherein the first audio data includes data indicative of a time series of frequency characteristics related to the audio of the target piece of music.
